(19) United States
(12) Patent Application Publication
(10) Pub. No.: US 2024/0147500 A1
(43) Pub. Date: May 2, 2024

(54) MECHANISMS FOR THE MEASUREMENTS AMONG UES

(71) Applicant: MEDIATEK INC., Hsinchu (TW)

(72) Inventor: Chiao-Yao Chuang, Hsinchu (TW)

(21) Appl. No.: 18/382,558

(22) Filed: Oct. 23, 2023

Related U.S. Application Data
(60) Provisional application No. 63/381,769, filed on Nov. 1, 2022.

(51) Int. Cl. H04W 72/25; H04L 5/00; H04W 28/26; H04W 72/51

(52) U.S. Cl. CPC H04W 72/25; H04L 5/0051; H04W 28/26; H04W 72/51

(57) ABSTRACT

In an aspect of the disclosure, a method, a computer-readable medium, and an apparatus are provided. The apparatus may be a first UE. The first UE transmits sidelink control information to one or more second UEs. The sidelink control information includes an indication of a first resource reserved for transmitting first sidelink positioning reference signals (SL-PRSs) from the first UE to the one or more second UEs. The sidelink control information includes an indication requesting the one or more second UEs to transmit second SL-PRSs to the first UE in response to receiving the first SL-PRSs from the first UE. The first UE transmits the first SL-PRSs on the first resource to the one or more second UEs.

### CROSS-REFERENCE TO RELATED APPLICATION(S)

This application claims the benefits of U.S. Provisional Application Ser. No. 63/381,769, entitled “REALIZING THE MEASUREMENT BETWEEN UES” and filed on Nov. 1, 2022, which is expressly incorporated by reference herein in their entirety.

### BACKGROUND

### Field

The present disclosure relates generally to communication systems, and more particularly, to techniques of performing measurements among user equipments (UEs).

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first UE. The first UE transmits sidelink control information to one or more second UEs. The sidelink control information includes an indication of first resource reserved for transmitting first sidelink positioning reference signals (SL-PRSs) from the first UE to the one or more second UEs. The sidelink control information includes an indication requesting the one or more second UEs to transmit second SL-PRSs to the first UE in response to receiving the first SL-PRSs from the first UE. The first UE transmits the first SL-PRSs on the first resource to the one or more second UEs.

In another aspect of the disclosure, a method, a computer-readable medium, and an apparatus are provided. The apparatus may be a second UE. The second UE receives sidelink control information from a first UE. The sidelink control information includes an indication of first resource reserved for the second UE receiving first sidelink positioning reference signals (SL-PRSs) from the first UE. The sidelink control information includes an indication requesting the second UE to transmit second SL-PRSs to the first UE in response to the second UE receiving the first SL-PRSs from the first UE. The second UE receives the first SL-PRSs on the first resource from the first UE. The second UE transmits the second SL-PRSs to the first UE in response to the second UE receiving the first SL-PRSs from the first UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating procedures for enabling measurements among multiple UEs under a decentralized network architecture.

FIG. 8 is a diagram illustrating transmissions of SL-PRSs between two UEs.

FIG. 9 is a sequence diagram illustrating operations for facilitating measurements among UEs under de-centralized mechanism for sidelink positioning.

FIG. 10 is a flow chart of a method (process) for transmitting SL-PRS.

FIG. 11 is a flow chart of a method (process) for receiving SL-PRSs.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

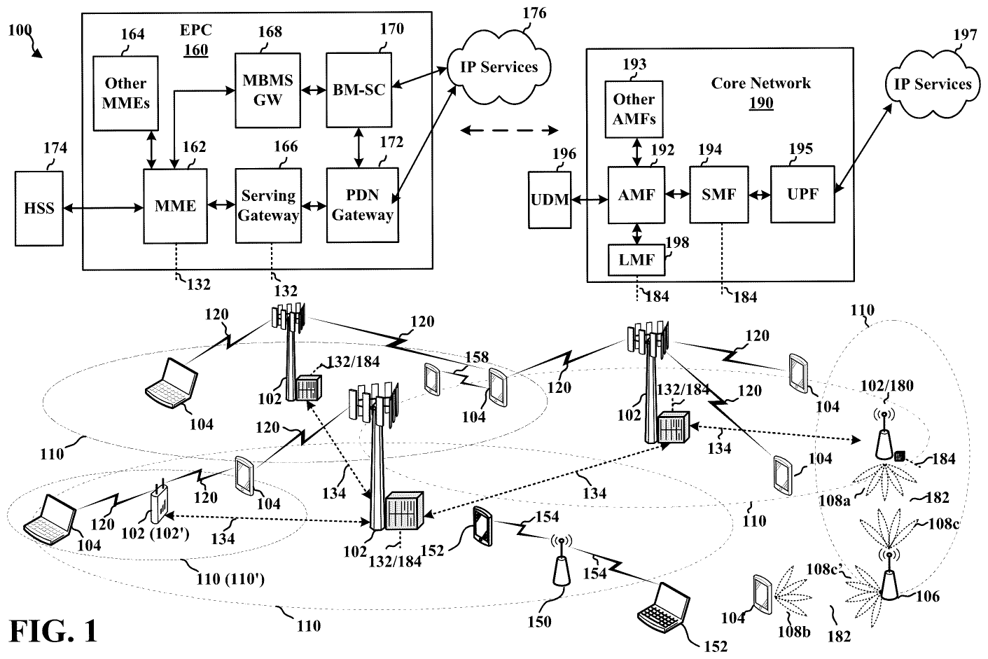

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to X MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

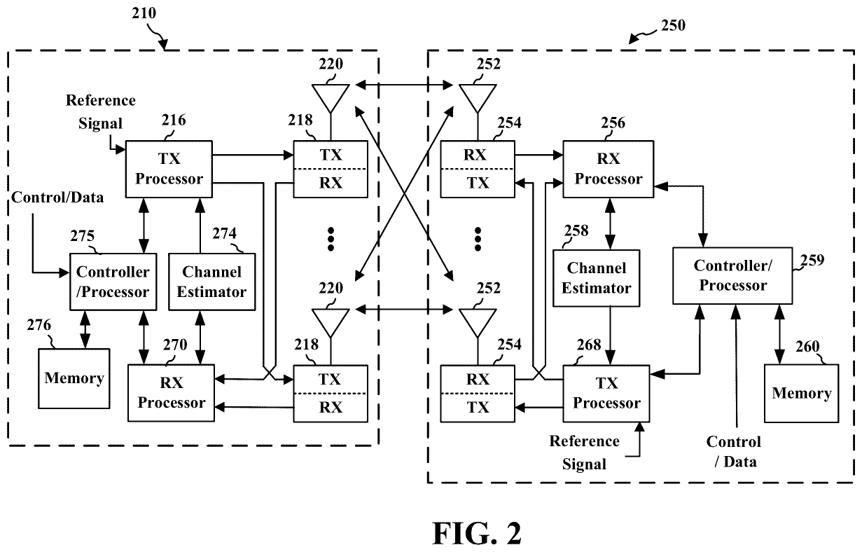

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

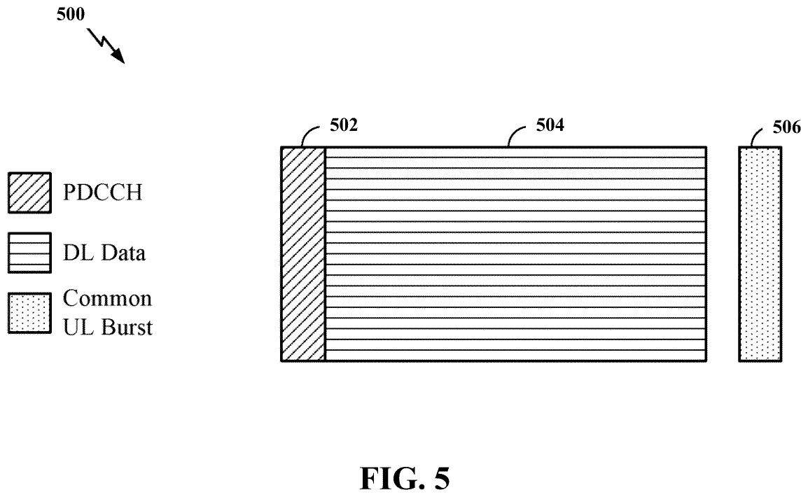

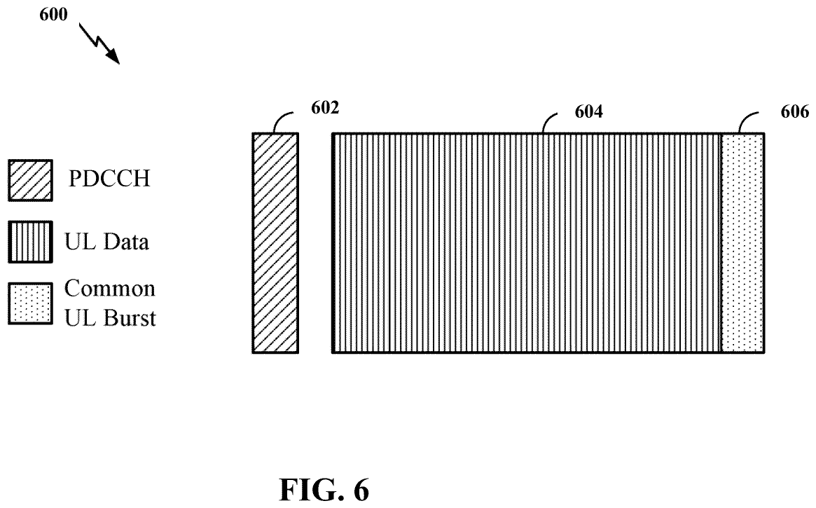

A single component carrier bandwidth of 100 MHz may be supported. In one example, NR resource blocks (RBs) may span 12 sub-carriers for each RB with a sub-carrier spacing (SCS) of 60 kHz over a 0.25 ms duration or a SCS of 30 kHz over a 0.5 ms duration (similarly, 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

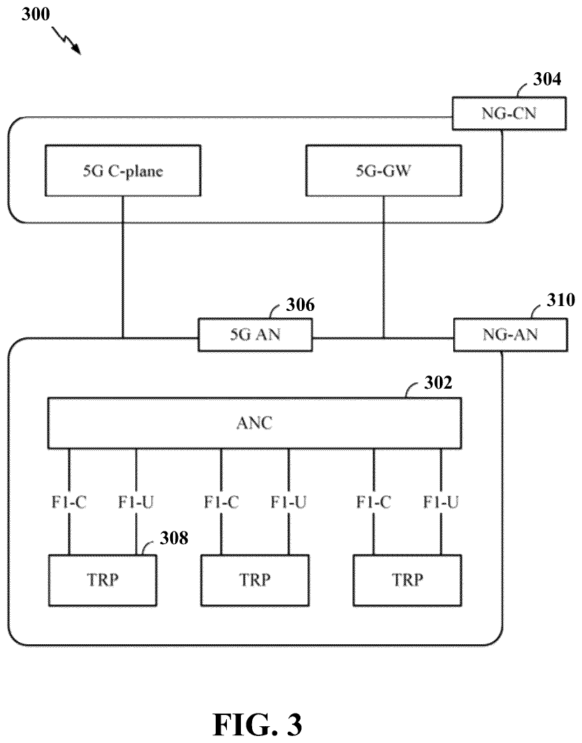

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

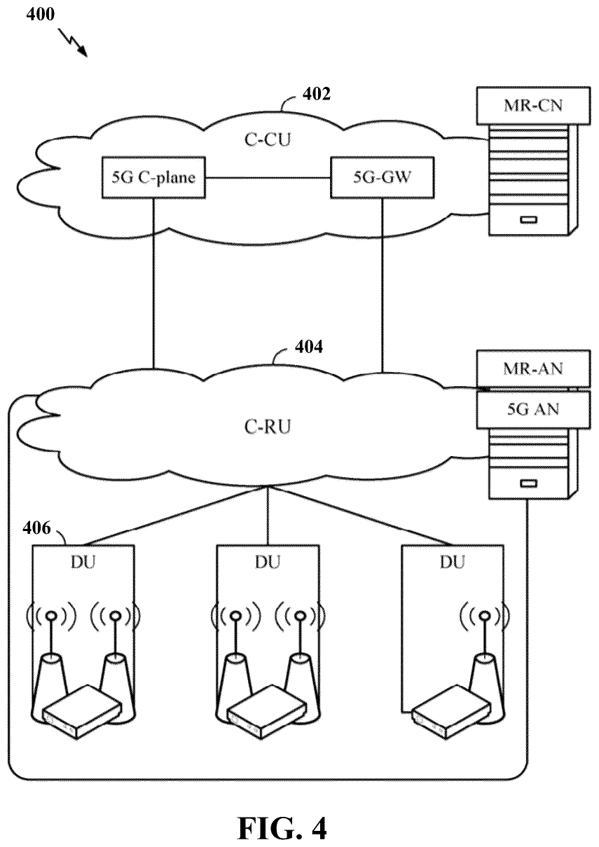

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

In a centralized network, for example with a next generation base station (gNB), and/or coordination through the core network for a group of gNBs, the time/frequency resources for transmission can be well controlled to reduce interference. This means the transmission by UEs is controlled by the network (base stations), and the transmission among gNBs can also be coordinated to reduce interference with each other.

The sidelink is the transmission between UEs. There are generally two cases where the centralized mechanism applies:
1. The transmission between a group of UEs is coordinated/determined by the gNB(s).
2. The transmission between a group of UEs is coordinated/determined by a master UE, when there is no network. This means a certain level of centralized mechanism may be feasible without a base station.

For a decentralized mechanism, the transmission between a group of UEs may rely on some mechanisms to reduce interference:
1. Sensing the time/frequency resources based on RSRP threshold to find out potential resources for transmission. Then select the resources that are not occupied (lower RSRP) for transmission.
2. When a UE transmits a signal in a slot, the UE can also deliver some information that the time/frequency resources are occupied. The UE can indicate in the control channel (e.g., Sidelink Control Information, SCI) that the current slot and a set of future slots are being reserved/occupied. Thus, when other UEs decode the SCI, they can know the occupancy status of future slots.

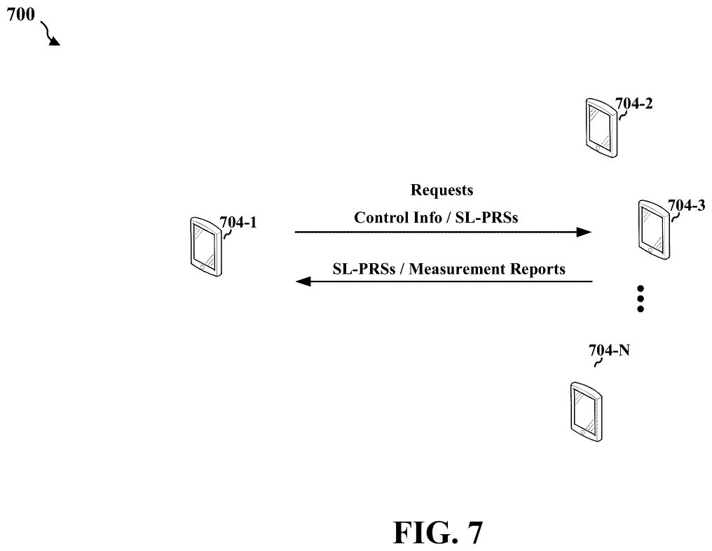

FIG. 7 is a diagram 700 illustrating procedures for enabling measurements among multiple UEs under a decentralized network architecture. A UE 704-1 may transmit a request to one or more other UEs 704-2, . . . , 704-N for performing measurements and/or transmitting signals such as SL-PRSs. This request may be broadcast if UE 704-1 does not know the IDs of nearby UEs. The UE 704-2, . . . , 704-N may respond by providing their capability for measurement and/or transmission, and granting the request.

To facilitate measurements, the UE 704-1 sends to the UEs 704-1, 704-2, . . . , 704-N SL-PRS parameters such as scrambling ID, time/frequency locations, and direction information or reference signals for spatial beamforming. Control channels like SCI may be used to transmit measurement requests and to request SL-PRS transmission between the UEs 704-1, 704-2, . . . , 704-N, due to their low latency. The UE 704-1 transmits the signals (e.g., SL-PRSs) for the UEs 704-2, 704-N to perform measurements. The UE 704-1 may receive measurement reports from the UE 704-2, . . . , 704-N. A server may receive measurement reports from the UE 704-1 and the UE 704-2, . . . , 704-N to compute positions.

Further, the UE 704-1 may suggest SL-PRS configurations for the UE 704-2, . . . , 704-N. The UE 704-2, . . . , 704-N may indicate conflicts with the suggested SL-PRS configurations. The UE 704-2, 704-N may suggest alternate SL-PRS configurations to the UE 704-1.

For example, for the UE 704-1 to receive the SL-PRSs from the UE 704-2 for measurement, the UE 704-1 needs the ID of the sequence for descrambling the received SL-PRSs. This allows the UE 704-1 to correctly decode the SL-PRSs transmitted from the UE 704-2. The UE 704-1 also needs the time and frequency location of the physical resources for the SL-PRSs, including whether it is periodic or semipersistent. This allows the UE 704-1 to receive the SL-PRSs at the correct time/frequency. The UE 704-1 further needs the direction information of the SL-PRS transmission from the UE 704-2, or the presence of another reference signal from the UE 704-2 having similar transmission direction as the SL-PRS. This information facilitates the UE 704-1 to adjust its beamforming before receiving the SL-PRS, in order to properly receive the directional SL-PRS signal. The other reference signal acts as the source of QCL type related to spatial receive parameter.

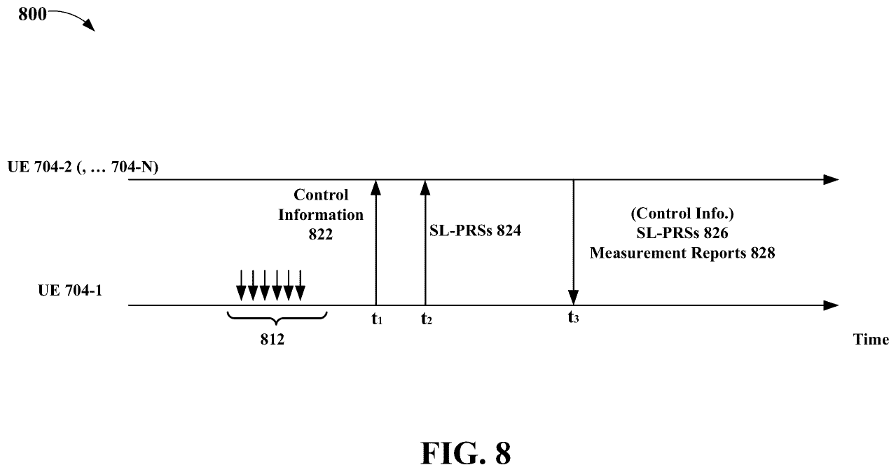

FIG. 8 is a diagram 800 illustrating transmissions of SL-PRSs between the UE 704-1 (target UE) and the UE 704-2 (anchor UE), etc. In a case without inter-UE coordination, the target UE 704-1 performs carrier sensing in a sensing window 812 prior to transmitting SL-PRS. For example, in the sensing window 812, the UE 704-1 senses the frequency domain resources by detecting/decoding the sidelink control channel (SCI) and measuring the received signal power (RSRP) of the resources. By decoding SCI, the UE 704-1 can detect if certain resources are already occupied by other UEs based on the reservation information. By measuring RSRP and comparing to a threshold, the UE 704-1 can detect which resources have low interference and are available for its own SL-PRS transmission. After sensing, the UE 704-1 selects suitable unoccupied resources with low interference for its SL-PRS transmission. The sensing window 812 may include consecutive slots prior to the slot where the UE 704-1 will transmit SL-PRSs. The UE 704-1 performs sensing continuously over these slots to determine the availability of resources. By performing sensing, the UE 704-1 avoids collisions and interference when transmitting SL-PRS in a decentralized network architecture without central coordination of resources.

The UE 704-1, the target UE, may send a request for measurement, and/or a request for SL-PRS transmission to the UEs 704-2, . . . , 704-N. The request could be within the data channel (PSSCH), control channel (2nd SCI), or PUSCH when there is connection with NW. The request could also be through the higher layer protocol or SL MAC-CE. The UEs 704-2, . . . , 704-N may follow an existing procedure to decode the control channel (SCI) and further decode the associated PSSCH to derive the request messages. The request could be via broadcast, groupcast, or unicast transmission types. Broadcast is applicable when the UE 704-1 does not have advance knowledge of nearby UEs. As such, the broadcast request polls for responses. For groupcast or unicast types, the UE 704-1 may have candidate UEs in advance to enable positioning methods. If the request is sent to the gNB or LMF, they can use the UE 704-1's initial position to arrange suitable UEs for inter-UE measurement. The request for measurement is for UEs 704-2, . . . , 704-N to measure SL-PRS from the UE 704-1. The request for transmission is for the UE 704-1 to measure SL-PRS from the UEs 704-2, . . . , 704-N. A single request could indicate both measurement and transmission for sidelink round trip time (SL-RTT). The request can also specify the positioning measurement type.

In this example, at a time point t₁, the UE 704-1 sends control information 822 to one or more of the UEs 704-2, . . . , 704-N. The control information 822 may contain one or more of the following:

The reservation by the UE 704-1 for the SL-PRS transmission, including the time/frequency resources, number of repetitions, periodicity, and number of transmissions. This allows other UEs (e.g., the UEs 704-2, . . . , 704-N) to know when and where the UE 704-1 transmits SL-PRSs.

The indication to the UEs 704-2, . . . , 704-N to transmit SL-PRS in response to receiving the SL-PRS from the UE 704-1. This triggers SL-PRS transmission by the other UEs.

The indication to the UEs 704-2, . . . , 704-N to send the measurement results to the UE 704-1 in response to receiving the SL-PRSs. This triggers the other UEs to send measurement reports 828.

Optionally, as the UE 704-1 conducted carrier sensing in the sensing window 812, the UE 704-1 may also include in the control information 822 the resource reservations for the UE 704-2, . . . , 704-N's SL-PRS transmissions in response to receiving SL-PRS from the UE 704-1. This reserves resources at the UE 704-1 for receiving SL-PRS from the other UEs, so that the anchor UEs do not need to perform sensing and resource selection.

Subsequently, at a time point t₂, the UE 704-1 transmits SL-PRSs 824 to the UEs 704-2, . . . , 704-N. In one configuration, the control information 822 is transmitted in a PSCCH. Further, the control information 822 may be the first SCI carried in the PSCCH. In one configuration, the control information 822 and the SL-PRSs 824 are transmitted in the same slot. In another configuration, the transmission of the control information 822 and the transmission of the SL-PRSs 824 have a slot offset.

Using the UE 704-2 as an example, after receiving the control information 822 from the UE 704-1, the UE 704-2 determines the reserved resources for the SL-PRSs 824 and may accordingly measure the SL-PRSs 824 and generate measurement reports 828.

Subsequently, when the control information 822 does not contain resources reservations for the UE 704-2, the UE 704-2 conducts carrier sensing similar to that of the UE 704-1 described supra to determine resources for SL-PRSs 826. Starting from a time point t₃, the UE 704-2 transmits, to the UE 704-1, control information for the SL-PRSs 826, the SL-PRSs 826, and the measurement reports 828 to the UE 704-1. Further, the measurement reports 828 may be independently sent to UE 704-1 or another entity for computation purpose.

In one configuration, when the control information 822 contains resources reservations for the UE 704-2, starting from a time point t₃, the UE 704-2 transmits, to the UE 704-1, the SL-PRSs 826 and the measurement reports 828 to the UE 704-1 using these reserved resources, without needing to perform sensing and resource selection. This reduces the latency in the sidelink relative positioning process.

In another configuration, the resources reservations for SL-PRS transmission and the resources reservations for measurement report transmission in the control information 822 are separate. Starting from a time point t₃, the UE 704-2 transmits the SL-PRSs 826 to the UE 704-1 using these reserved resources, without needing to perform sensing and resource selection. The measurement reports 828 may be transmitted later using reserved resources indicated in the control information 822 or using resources determined by the UE 704-2 through sensing. Separating the transmission of the SL-PRSs 826 and the measurement reports 828 allows reducing latency for the SL-PRS transmissions while providing flexibility in the delivery of the measurement reports.

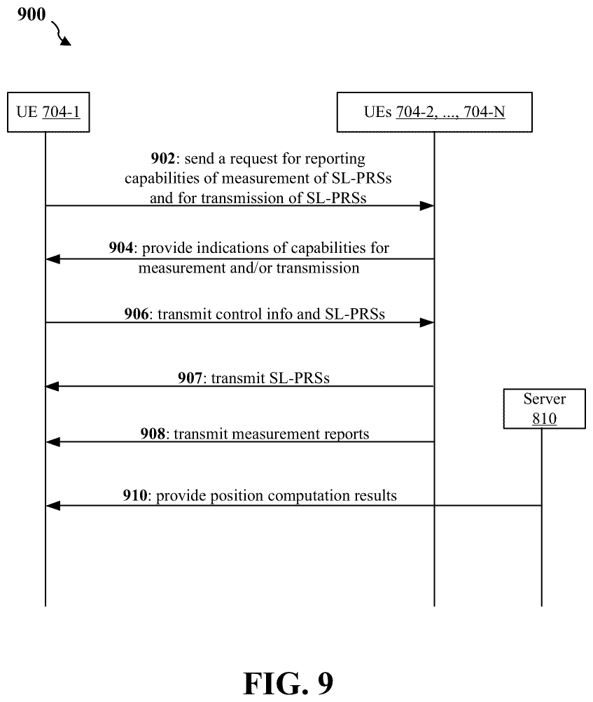

FIG. 9 is a sequence diagram 900 illustrating operations for facilitating measurements among UEs under de-centralized mechanism for sidelink positioning. In operation 902, the UE 704-1 sends to one or more of the UEs 704-2, . . . , 704-N a request for reporting capabilities of measurement of SL-PRSs and for transmission of SL-PRSs. That is, the UE 704-1 may request one or more of the UE 704-2, . . . , 704-N to report their capabilities for receiving SL-PRSs from the UE 704-1 for measurement and report as well as for transmitting SL-PRSs of their own. For example, the UE 704-1 may broadcast a request to one or more of the UEs 704-2, . . . , 704-N for reporting capabilities of transmission and measurement of SL-PRSs. Since the UE 704-1 does not know the identities of nearby UEs, it broadcasts the request as a poll.

In operation 904, one or more of the UEs 704-2, . . . , 704-N may response to the UE 704-1 with their capabilities for measurement and/or transmission. Upon receiving the responses, the UE 704-1 learns the identities of the responding UEs. In one example, the one or more UEs may respond with grant for measurement and/or transmission to the UE 704-1. The grant means the acceptance of the request from the UE 704-1, and each UE in the UE 704-2, . . . , 704-N granting the request may provide the capability for measurement and/or transmission. The transmission capability could be, for example, the number of transmit beams supported, or the path loss RS measurement capability for transmission. The UE 704-2, . . . , 704-N may also request the UE 704-1 for measurement and transmission.

In operation 906, the UE 704-1 transmits control information and SL-PRSs to the one or more of the UEs 704-2, . . . , 704-N. The control information provides some SL-PRS configurations (e.g., time/frequency resource locations) for the SL-PRS transmission to the UE 704-2, . . . , 704-N. Some SL-PRS configurations (e.g., sequence ID) for the SL-PRS may be provided by higher layer messages.

Optionally, the UE 704-2, . . . , 704-N may grant the SL-PRS configuration from the UE 704-1 for transmission. Each UE in the UE 704-2, . . . , 704-N may indicate whether it can receive the SL-PRS from the UE 704-1. The priority rule for reception may also be defined and may reply the rule to the UE 704-1.

The UE 704-1 may optionally provide some recommended/preferred SL-PRS configurations for the UE 704-2, . . . , 704-N to transmit SL-PRSs to the UE 704-1. That is, the UE 704-1 may also provide suggested SL-PRS configuration and reserve resources for potential transmission from the UE 704-2, . . . , 704-N to the UE 704-1. If the UE 704-1 also requests SL-PRS transmission from the UE 704-2, . . . , 704-N. However, some UEs may not adopt the suggested SL-PRS configuration, for example, because they have been transmitting SL-PRS to another group of UEs. As such, these UEs may provide the in-use SL-PRS configuration to the UE 704-1 during the transmission to the UE 704-1.

Further, as the UE 704-1 performs sensing and resource selection, the UE 704-1 may suggest SL-PRS configurations and resources for the UE 704-2, . . . , 704-N. The UE 704-1 provides this suggestion information through MAC control elements (CEs) or higher layer signaling without reserving the resources. It is up to the UE 704-2, . . . , 704-N to determine whether to use the suggested resources. If a UE decides to use the suggested resources, it reserves these resources by indicating them in the control channel when transmitting SL-PRSs.

In one example, after the UE 704-2 receives the SL-PRS signals transmitted from the UE 704-1, the UE 704-2 estimates the signal-to-noise ratio (SNR) based on the received signals. If the SNR is not good enough for positioning measurements, the UE 704-2 suggests the UE 704-1 to change the SL-PRS configuration. For example, the UE 704-2 suggests different time/frequency resources or larger SL-PRS symbol numbers, which provide better SNR from the receiver's perspective.

In operation 907, one or more of the UEs 704-2, . . . , 704-N transmits SL-PRSs to the one or more of the UE 704-1, as requested by the UE 704-1. When the UE 704-1 does not reserve the resource for SL-PRS transmission to the UE 704-1, the UEs 704-2, . . . , 704-N may perform carrier sensing themselves and determine resources for SL-PRS transmission. Otherwise, the UEs 704-2, . . . , 704-N may use the resources reserved by the UE 704-1 for such transmissions.

In operation 908, the UE 704-1 receives measurement reports from one or more of the UE 704-2, . . . , 704-N. At least for RTT measurement for relative positioning, the UE 704-1 needs to derive the sidelink based RX-TX time difference measurement in the UE 704-2, . . . , 704-N to further derive the RTT result.

In operation 910, a server 810 may provide the position computation results to the UEs after the server 810 receives the measurement reports (among the UE 704-1, the UE 704-2, . . . , 704-N as described supra). The UE 704-1, the UE 704-2, . . . , 704-N may send the measurement reports and/or the corresponding location information (coordinates) to the server 810. After computation, the server 810 sends back the position.

Optionally, the UE 704-1 may initiate a conflict resolution. For example, during operation 906, the UE 704-1 may see the feedback of SL-PRS configuration provided by the UE 704-2, . . . , 704-N and sense that there are conflicts among the UE 704-2, . . . , 704-N. Therefore, further conflict resolution is required.

The SL-PRS related configuration, activation, and triggering between the UEs 704-1, 704-2, . . . , 704-N can be facilitated. The SL-PRS transmission request and measurement request between the UEs 704-1, 704-2, . . . , 704-N may be facilitated through MAC CEs or a first SCI or a second SCI transmitted on the sidelink.

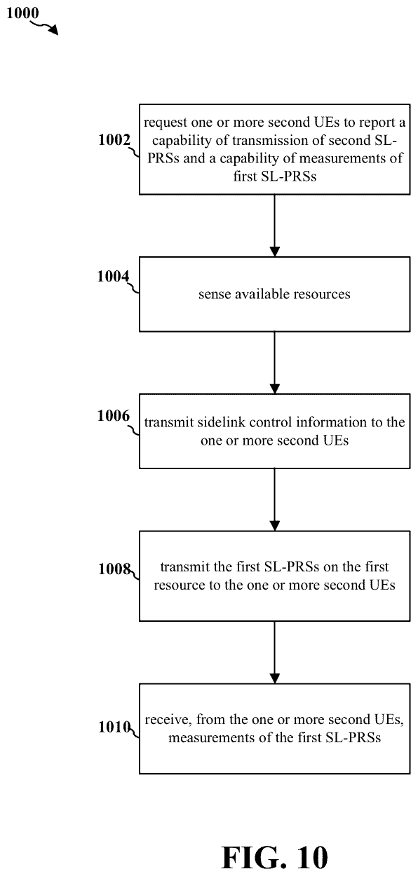

FIG. 10 is a flow chart 1000 of a method (process) for transmitting SL-PRS. The method may be performed by a first UE (e.g., the UE 704-1). In operation 1002, the first UE requests one or more second UEs to report a capability of transmission of the second SL-PRSs and a capability of measurements of first SL-PRSs. In operation 1004, the first UE senses available resources.

In operation 1006, the first UE transmits sidelink control information to the one or more second UEs (e.g., the UEs 704-2, . . . , 704-N). The sidelink control information includes an indication of first resource reserved for transmitting first sidelink positioning reference signals (SL-PRSs) from the first UE to the one or more second UEs. The sidelink control information also includes an indication requesting the one or more second UEs to transmit second SL-PRSs to the first UE in response to receiving the first SL-PRSs from the first UE.

In operation 1008, the first UE transmits the first SL-PRSs on the first resource to the one or more second UEs. In certain configurations, the sidelink control information and the first SL-PRSs are transmitted in a same transmission slot. In certain configurations, the sidelink control information further includes an indication triggering the one or more second UEs to transmit measurements of the first SL-PRSs to the first UE in response to receiving the first SL-PRSs from the first UE. In certain configurations, the sidelink control information further includes an indication of second resource reserved for the one or more second UEs to transmit the second SL-PRSs to the first UE. In certain configurations, the first UE performs sensing of available resources and selects, based on the sensing, second resource for the one or more second UEs to transmit the second SL-PRSs. The first UE then transmits, via a medium access control (MAC) control element (CE) or higher layer signaling, indications of the second resource to the one or more second UEs for transmitting the second SL-PRSs.

In certain configurations, the first UE receives, from at least one of the one or more second UEs, second control information including an indication that the at least one second UE will use the second resource for transmitting the second SL-PRSs to the first UE. In certain configurations, the second control information includes a reservation, by the at least one second UE, of the second resource.

In operation 1010, the first UE receives, from the one or more second UEs, measurements of the first SL-PRSs.

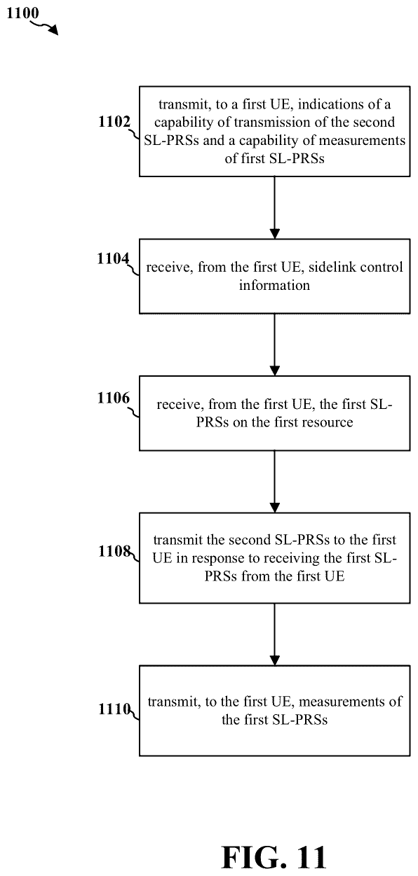

FIG. 11 is a flow chart 1100 of a method (process) for receiving SL-PRSs. The method may be performed by a second UE (e.g., the UE 704-2). In operation 1102, the second UE transmits, to a first UE, indications of a capability of transmission of the second SL-PRSs and a capability of measurements of first SL-PRSs. In operation 1104, the second UE receives, from the first UE, sidelink control information. The sidelink control information includes an indication of first resource reserved for receiving the first SL-PRSs from the first UE. The sidelink control information also includes an indication requesting the second UE to transmit second SL-PRSs to the first UE in response to receiving the first SL-PRSs from the first UE. In certain configurations, the sidelink control information further includes an indication triggering the second UE to transmit measurements of the first SL-PRSs to the first UE in response to receiving the first SL-PRSs from the first UE. In certain configurations, the sidelink control information further includes an indication of second resource reserved for the second UE to transmit the second SL-PRSs to the first UE.

In operation 1106, the second UE receives, from the first UE, the first SL-PRSs on the first resource. In certain configurations, the sidelink control information and the first SL-PRSs are received in a same transmission slot.

In operation 1108, the second UE transmits the second SL-PRSs to the first UE in response to receiving the first SL-PRSs from the first UE. In certain configurations, the second UE transmits, to the first UE, second control information including a reservation of the second resource for transmitting the second SL-PRSs. In certain configurations, the second UE receives, from the first UE via a medium access control (MAC) control element (CE) or higher layer signaling, indications of second resource for transmitting the second SL-PRSs. In certain configurations, the second UE performs sensing of available resources and selects, based on the sensing, resources to transmit the second SL-PRSs when the sidelink control information from the first UE does not indicate resources reserved for transmitting the second SL-PRSs.

In operation 1110, the second UE transmits, to the first UE, measurements of the first SL-PRSs.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a first user equipment (UE), comprising:
transmitting sidelink control information to one or more second UEs, wherein the sidelink control information includes:
an indication of a first resource reserved for transmitting first sidelink positioning reference signals (SL-PRSs) from the first UE to the one or more second UEs; and
an indication requesting the one or more second UEs to transmit second SL-PRSs to the first UE; and
transmitting the first SL-PRSs on the first resource to the one or more second UEs.

2. The method of claim 1, wherein the sidelink control information further includes an indication triggering the one or more second UEs to transmit measurements of the first SL-PRSs to the first UE in response to receiving the first SL-PRSs from the first UE.

3. The method of claim 1, wherein the sidelink control information further includes an indication of a second resource reserved for the one or more second UEs to transmit the second SL-PRSs to the first UE.

4. The method of claim 1, further comprising:
requesting the one or more second UEs to report a capability of transmission of the second SL-PRSs and a capability of measurements of the first SL-PRSs.

5. The method of claim 1, wherein the sidelink control information and the first SL-PRSs are transmitted in a same transmission slot.

6. The method of claim 1, further comprising:
receiving, from the one or more second UEs, measurements of the first SL-PRSs.

7. The method of claim 1, further comprising:
sensing available resources prior to transmitting the sidelink control information and the first SL-PRSs.

8. The method of claim 1, further comprising:
performing sensing of available resources;
selecting, based on the sensing, second resource for the one or more second UEs to transmit the second SL-PRSs;
transmitting, via a medium access control (MAC) control element (CE) or higher layer signaling, indications of the second resource to the one or more second UEs for transmitting the second SL-PRSs.

9. The method of claim 8, further comprising:
receiving, from at least one of the one or more second UEs, second control information including an indication that the at least one second UE uses the second resource for transmitting the second SL-PRSs to the first UE.

10. The method of claim 9, wherein the second control information includes a reservation, by the at least one second UE, of the second resource.

11. A method of wireless communication of a second user equipment (UE), comprising:
receiving, from a first UE, sidelink control information, wherein the sidelink control information includes:
an indication of a first resource reserved for receiving first sidelink positioning reference signals (SL-PRSs) from the first UE; and
an indication requesting the second UE to transmit second SL-PRSs to the first UE;
receiving, from the first UE, the first SL-PRSs on the first resource; and
transmitting the second SL-PRSs to the first UE.

12. The method of claim 11, wherein the sidelink control information further includes an indication triggering the second UE to transmit measurements of the first SL-PRSs to the first UE.

13. The method of claim 11, wherein the sidelink control information further includes an indication of a second resource reserved for the second UE to transmit the second SL-PRSs to the first UE.

14. The method of claim 11, further comprising:
transmitting, to the first UE, indications a capability of transmission of the second SL-PRSs and a capability of measurements of the first SL-PRSs.

15. The method of claim 11, wherein the sidelink control information and the first SL-PRSs are received in a same transmission slot.

16. The method of claim 11, further comprising:
transmitting, to the first UE, measurements of the first SL-PRSs.

17. The method of claim 11, further comprising:
performing sensing of available resources; and
selecting, based on the sensing, resources to transmit the second SL-PRSs when the sidelink control information from the first UE does not indicate resources reserved for transmitting the second SL-PRSs.

18. The method of claim 11, further comprising:
receiving, from the first UE via a medium access control (MAC) control element (CE) or higher layer signaling, indications of second resource for transmitting the second SL-PRSs.

19. The method of claim 18, further comprising:
transmitting, to the first UE, second control information including a reservation of the second resource for transmitting the second SL-PRSs.

20. An apparatus for wireless communication, the apparatus being a first user equipment (UE), comprising:
a memory; and
at least one processor coupled to the memory and configured to:
transmit sidelink control information to one or more second UEs, wherein the sidelink control information includes:
an indication of first resource reserved for transmitting first sidelink positioning reference signals (SL-PRSs) from the first UE to the one or more second UEs; and
an indication requesting the one or more second UEs to transmit second SL-PRSs to the first UE in response to receiving the first SL-PRSs from the first UE; and
transmit the first SL-PRSs on the first resource to the one or more second UEs.
